(19) United States
(12) Patent Application Publication
(10) Pub. No.: US 2018/0364071 A1
(43) Pub. Date: Dec. 20, 2018

(54) PHOTONIC COMPUTER SYSTEM COMPRISED OF STACK DISK ARRAYS RUNNING ON BUT NOT LIMITED TO QUANTUM SOFTWARE

(71) Applicant: Daniel Rivera, Modesto, CA (US)

(72) Inventor: Daniel Rivera, Modesto, CA (US)

(21) Appl. No.: 15/624,711

(22) Filed: Jun. 16, 2017

(51) Int. Cl. G01D 5/26; G02B 6/38; G01D 5/353; G02B 6/42

(52) U.S. Cl. CPC G01D 5/268; G02B 6/3874; H04B 10/40; G01D 5/35377; G02B 6/4248; G01D 5/35374

(57) ABSTRACT

A new compact, scalable, self-contained, highly efficient computer system comprised of stackable microchips within a thermal vessel. The power fed to this computer system is simultaneously transmitted directly & via a tuned resonance frequency to and through each stacked microchip and regulated via several feedback sensory coils. Inductive transceiver coils established within the microchip condition and redistribute power to its adjacent chipset. Fiber optics & power cables are located within the photonic tubular core to allow gated communication between stacked microchips. Alignment and separation of said microchips is maintained by controlled magnetic & electromagnetic poles.

### BACKGROUND FIELD OF INVENTION

Supercomputers are traditionally made of fiber optically linked computers mounted in racks or cabinets. These cabinets are water-cooled or air-cooled requiring heat exchangers and or large air conditioning units. This classic type of system configuration tends to be very non-energy efficient. In addition, these supercomputer system require not only a big demand on power, but require a large building to house the classic supercomputer system, i.e. IBM Roadrunner.

### BRIEF SUMMARY OF THE INVENTION

This invention remedies the supercomputer problem mentioned by providing a new compact, scalable, self-contained, highly efficient Photonic Supercomputer System (PSS). This supercomputer system is designed for maximum scalability and high-end processing power, high-end processing power that can emulate today's existing supercomputers. This Photonic supercomputer system is a quantum leap in design, performance & reliability. It is lightyears ahead of the competition, for it is modular, but yet integral in nature. This invention should be classified as a TAO Product. This invention is the Swiss Army Knife of computing and is codenamed ‘Lighthouse’.

This invention works via a fiber-optic core & hub principal. The whole wafer is used as a primary design with exception to its hollow core. The larger die greatly reduces the cost of the supercomputer system and offers greater control, operational reliability and throughput. The center of the wafer cores are cut out and utilized for tertiary components of the build. It should be know that this stated invention can be engineered as a supercomputer system or engineered as a standalone personal computer system depending on the disk array layout, cooling mediums, OS software and peripheral communications.

The basic objective of this invention is to Command, Communicate & Control Data.

Command is achieved by the SUPERUSER(s)

Communication is achieved by the software & hardware module(s).

Control is achieved by the software & hardware module(s).

### Novel Features

CHIPSETS:
   Powered directly & via inductive resonance controlled via feedback coils
   Chipset proximity requires smaller optic transceivers for throughput unlike current server farms. (Offering Greater Power Savings)
   Design provides ease of expandability for speed & memory, etc
   Provides ease of system maintenance due to its' modular design
REDUNDANT FIBER-OPTIC HUB SPOKE ARRANGEMENTS:
   Provides higher speeds & offers greater communication reliability between chipsets
REDUNDANT POWER FEEDS & SELF CONTAINED POWER BACKUPS
   Direct, Inductive & Relative Radiated Power
VESSEL HOUSINGS:
   Numerous Vessel Types & Sizes to meet MIL temp hardened specifications needed for high demand applications

Further features of the invention, its nature and various advantages will be more apparent from the accompanying drawings and the following detailed description of the preferred embodiments.

### BRIEF DESCRIPTION OF THE DRAWINGS

SECTION 1: BASIC VESSEL

FIG. 1: VESSEL BASE—ISOMETRIC VIEW, SW

FIG. 2: VESSEL BASE—CROSS-SECTIONAL VIEW, SW

FIG. 3: VESSEL BASE—CROSS-SECTIONAL VIEW, WIREFRAME

FIG. 4: VESSEL BASE—CROSS-SECTIONAL VIEW, S3

FIG. 5: VESSEL BASE—CROSS-SECTIONAL VIEW, S5

SECTION 2: EXTERNAL COMPONENTS—POWER SUPPLY & HYRBRID CABLE

FIG. 6: EXTERNAL POWER SUPPLY

FIG. 7: EXTERNAL HYBRID (COPPER & FIBER) CABLE

SECTION 3: INTERNAL ELECTRONIC COMPONENTS

FIG. 8: ELECTRONIC INDUCTIVE COILS MOUNTED ON FLAT MEMBRANE

FIG. 9: ELECTRONIC COMPONENT LAYOUT

FIG. 10: ELECTRONIC FUNCTIONAL BLOCK DIAGRAM

SECTION 4: CHIPSET FLOORPLANS

FIG. 11: CHIPSET CORE RING FLOORPLAN—CROSS-SECTIONAL, TOP VIEW (TV)

FIG. 12: CHIPSET CORE ISOLATIVE FLOORPLAN—CROSS-SECTIONAL, SIDE VIEW

FIG. 13: CHIPSET CORE INDUCTIVE & MAGNETIC FLOORPLAN—CROSS-SECT, TV

FIG. 14: CHIPSET—uP COMPONENT FLOORPLAN EXPANDED—CROSS-SECTIONAL

FIG. 15: CHIPSET—uP COMPONENT FLOORPLAN STACKED—CROSS-SECTIONAL

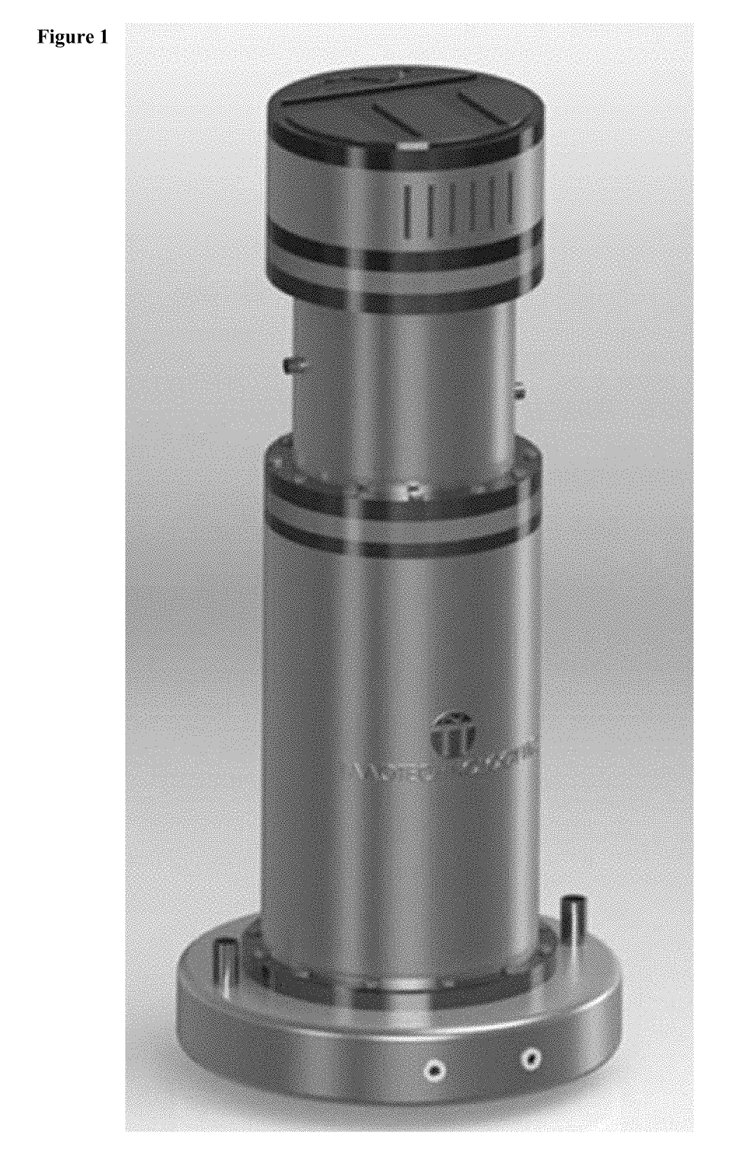

### Brief Description of the Drawings (Continued)

SECTION 5: CHIP & PHOTONIC CORE DETAILS

FIG. 16: CHIP WITH KEY LAYOUT ASSEMBLY

FIG. 17: CENTER SAFT GROOVES TO MATCH CHIP WITH KEY LAYOUT ASSEMBLY

FIG. 18: FIBER OPTIC & POWER BACKBONE LAYOUT WITH FLUX AND FLUID LAYOUT

SECTION 6: CHIPSET/VESSEL SYSTEM CONFIGURATIONS

FIG. 19: CHIPSET ASSIGNMENT ARRAY FOR PERSONAL PC

FIG. 20: CHIPSET ASSIGNMENT ARRAY FOR SUPERCOMPUTER

SECTION 7: MAS VESSEL DESIGN LAYOUT OPTIONS

FIG. 21: MAS LAYOUT (MODULAR STACK ARRAY WITHIN COLUMN)

FIG. 22: MAS LEGEND

FIG. 23: MAS LAYOUT (MODULAR STACK ARRAY WITHIN TOROID)

FIG. 24: AGGREGATION OF SEVERAL MAS TOROIDS IN LINEAR ARRAY

FIG. 25: AGGREGATION OF NUMEROUS MAS TOROIDS IN CHAIN ARRAY

FIG. 26: ADDITIONAL HOUSING & MOUNT TYPES: VERTICAL/HORIZONAL PLANE

FIG. 27: ADDITIONAL HOUSING & MOUNT TYPES: TORROIDAL

FIG. 28: ADDITIONAL HOUSING & MOUNT TYPES: SPHERICAL

### Brief Description of the Drawings (Continued)

SECTION 8: LAB SETUP

FIG. 29: TAAO TOWER LAB SETUP

FIG. 30: U.S. Pat. No. 5,953,376—Probabilistic trellis coded modulation with PCM-derived constellations

FIG. 31: PHOTONIC OPTIC CORE TO DISPS EFFICIENCIES

FIG. 32: DISPS TO DISPS OPTICAL LOSS WITHOUT AND WITH MAG ALIGNMENT

FIG. 33: DISPS POWER TRANSFER SCHEME MAKUP

FIG. 34: POWER TRANSFER SCHEMES

FIG. 35: MAGNETIC RESONANCE SHAPING—OPTICAL AFFECT

FIG. 36: MAGNETIC RESONANCE SHAPING—POWER AFFECT

FIG. 37: FLUID FLOW RATES BASED ON DIAMETER OF CYLINDER

FIG. 38: VENT SETTINGS BASED ON DIAMETER OF CYLINDER

FIG. 39: DISPS ISOLATION DISTANCE (cm).

SECTION 9: WAN LAYOUT

FIG. 40: COMMERCIAL NETWORK UTILIZATION OF TAAO TOWERS

FIG. 41: COMMAND CENTER CUBICAL 1 of 250

### DETAILED DESCRIPTION OF THE PREFERRED EMBODIMENT

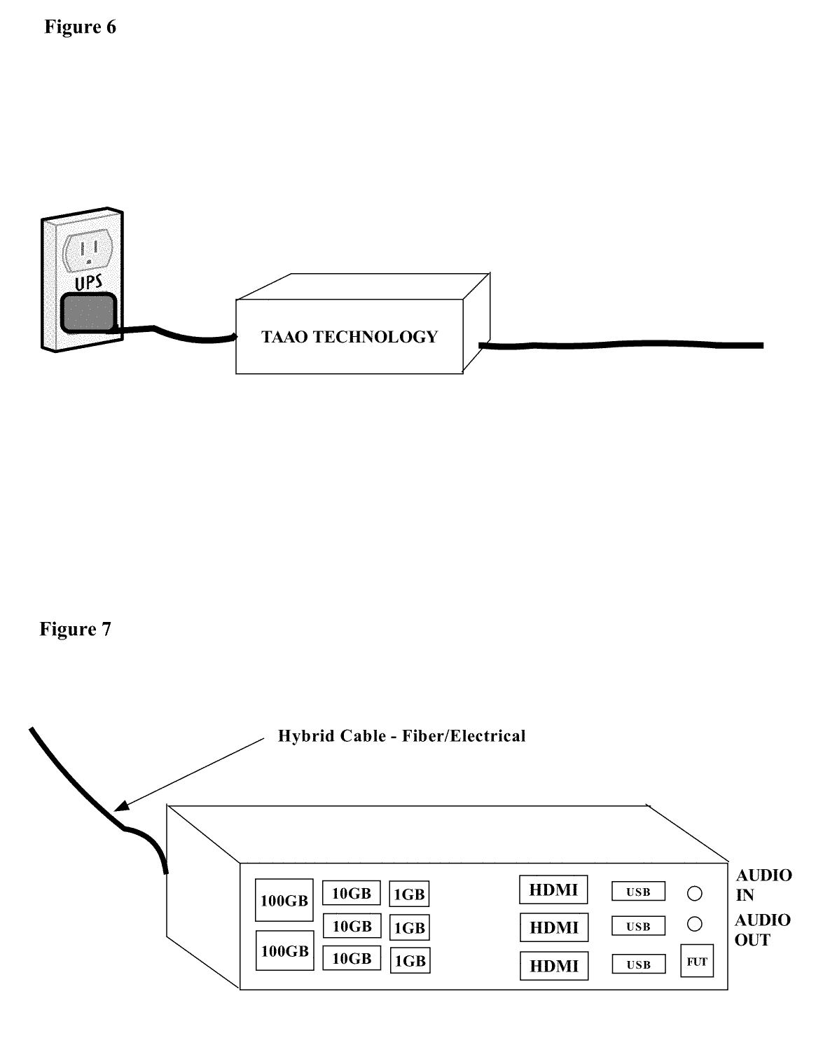

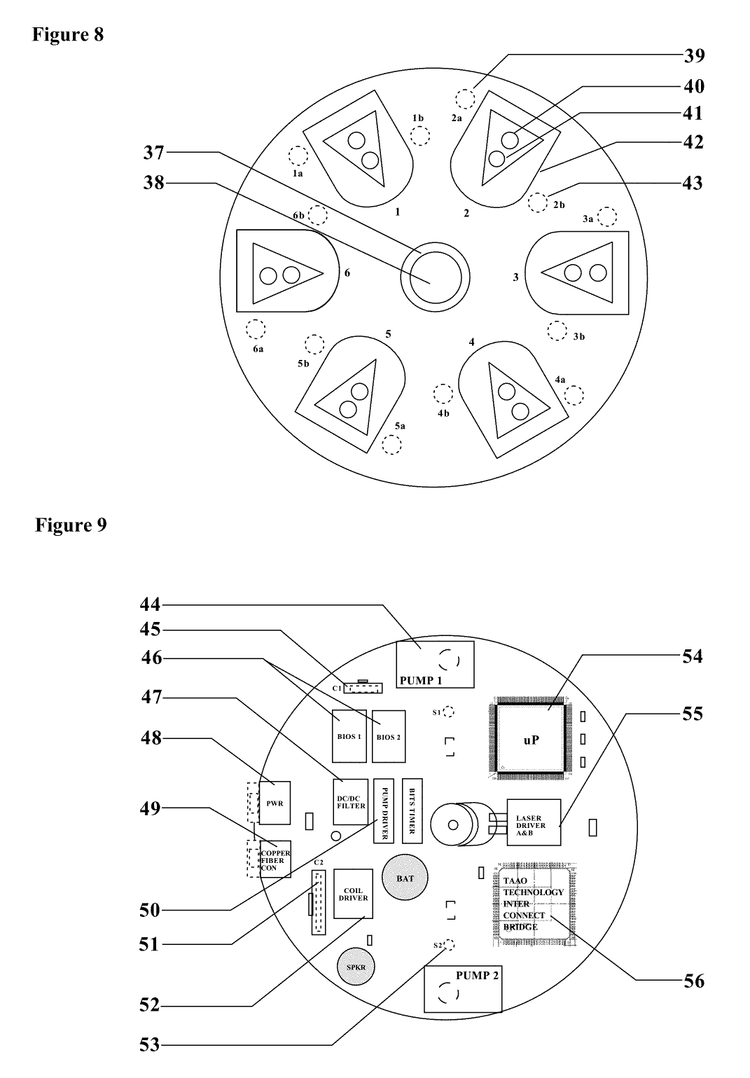

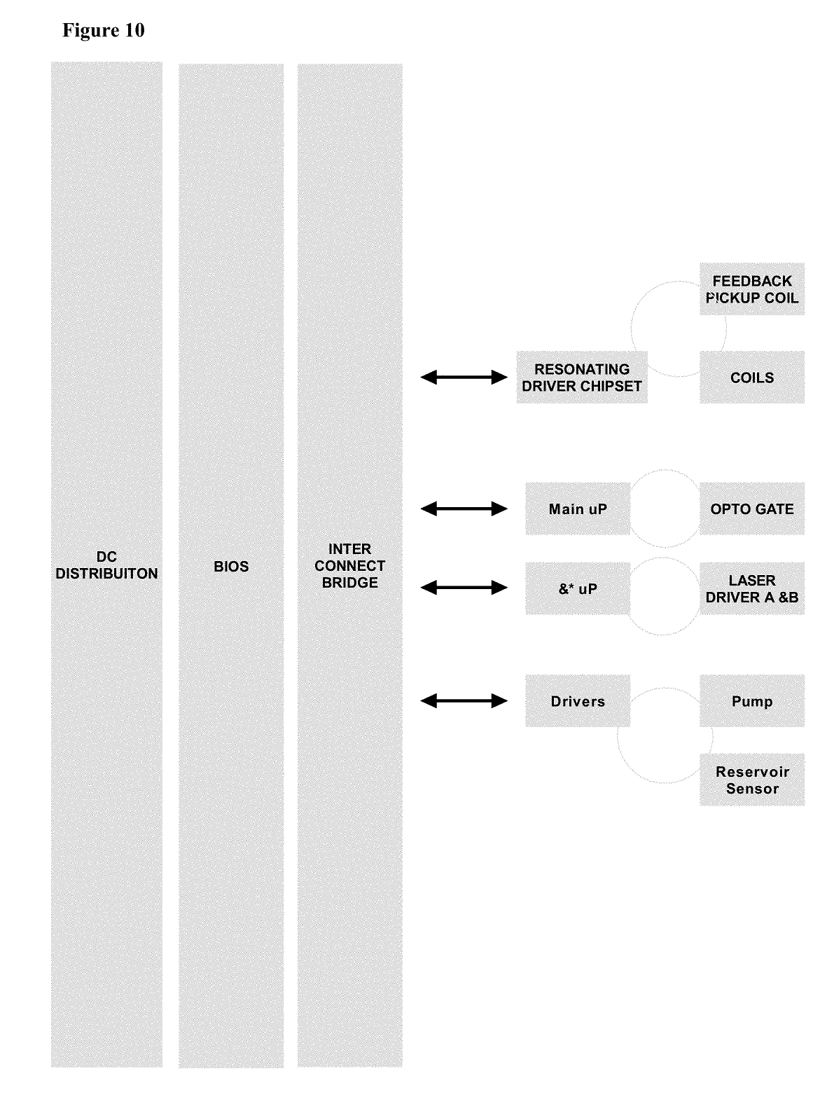

Power Feed & Type: Power is applied to the TAAO Computer System by plugging in the power adapter to wall outlet as noted in FIG. 6 and to a power jack 48 as noted in FIG. 9. Power passes through a DC to DC converter/filter then to a power distribution as shown in FIG. 10.

System Boot: Is achieved via Dual TAAO Bios 46. The TAAO Bios registers, via the Opto Gate, the needed wavelengths based on the types and number of chipsets used, FIG. 19 and FIG. 20. The Interconnect Bridge engages power to the Main/Host processor and com with each Vessel Chipsets normalizing direct & inductive power to each with the aid of pickup feedback coils.

Resonant Coil Types: Transmit coils 42 work in unison to provide effective and efficient resonance to stacked chipsets 15 located within the vessel 14. An inductive layer 81 surrounds each chipset so as to act as a power resonance repeater to the adjacent chipset in series as illustrated in FIG. 18.

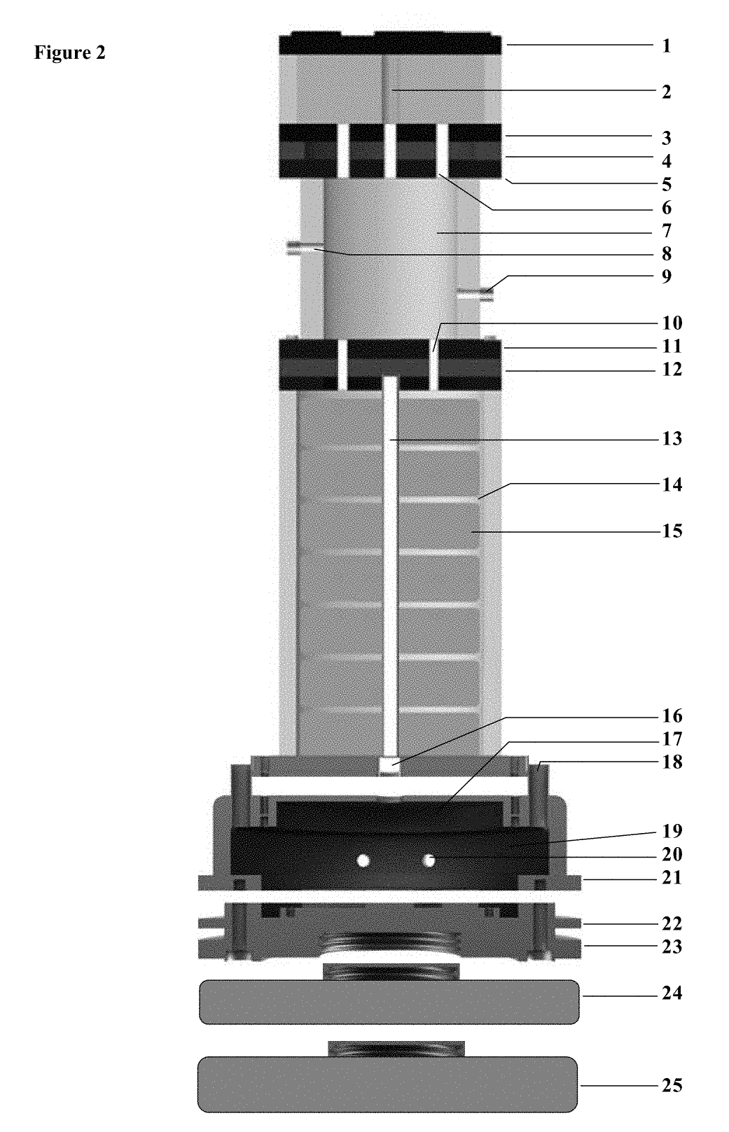

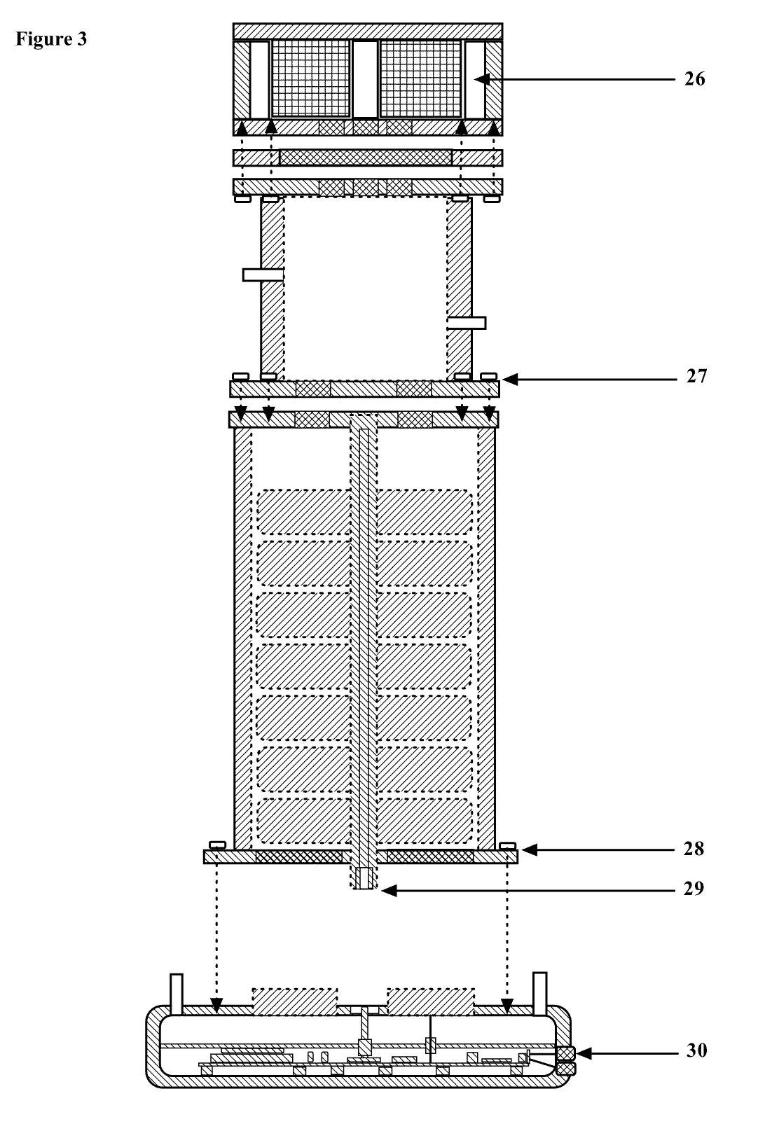

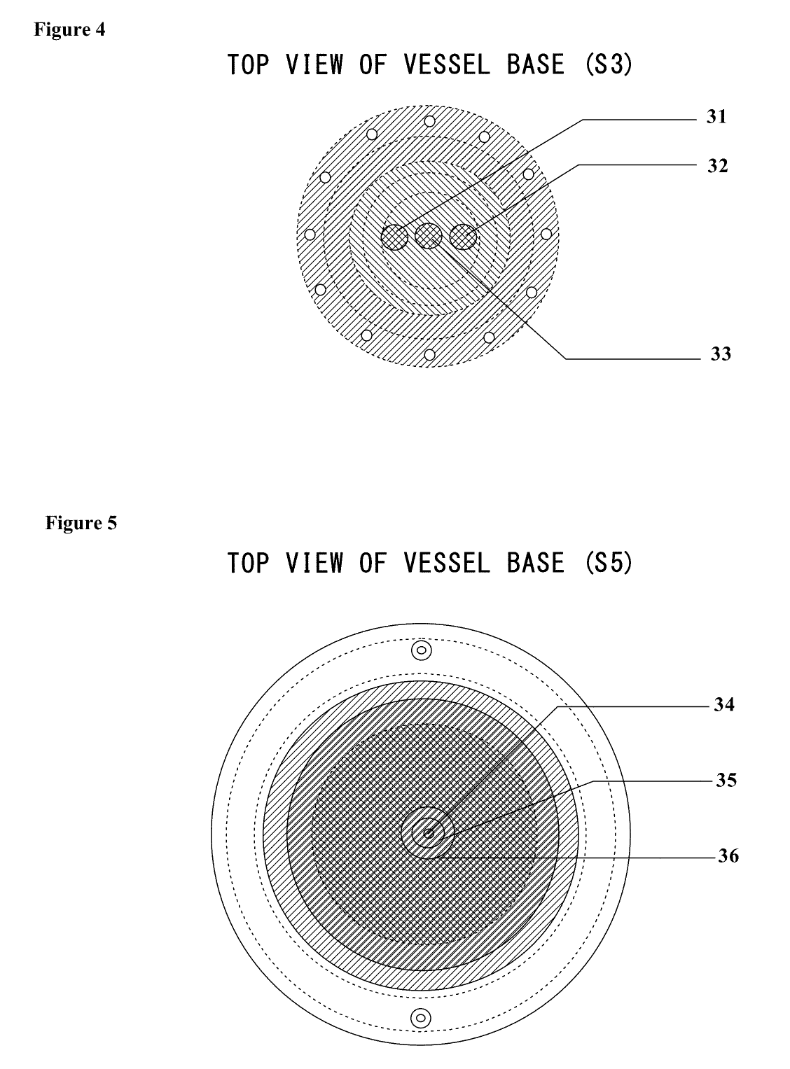

Pump Types: Radial Flow Pumps 44 as shown in FIG. 7 go active bringing desired liquid cooling to lower 19, mid 13 and top 7 vessels as shown in FIG. 2.

Differing Tube Types: Polyurethane, aluminum, copper, stainless steel are utilized to bring an established amount of flow/thermal conduction to the vessel.

Variable Slide Vents 6, 26 maintain proper vessel pressurization.

### Detailed Description of the Preferred Embodiment (Continued)

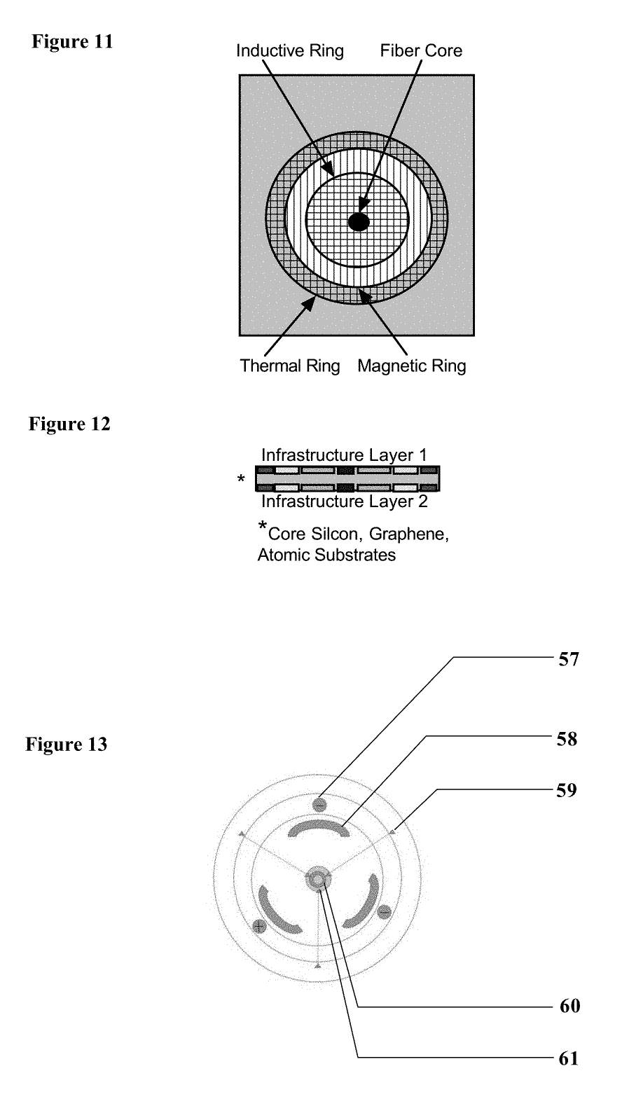

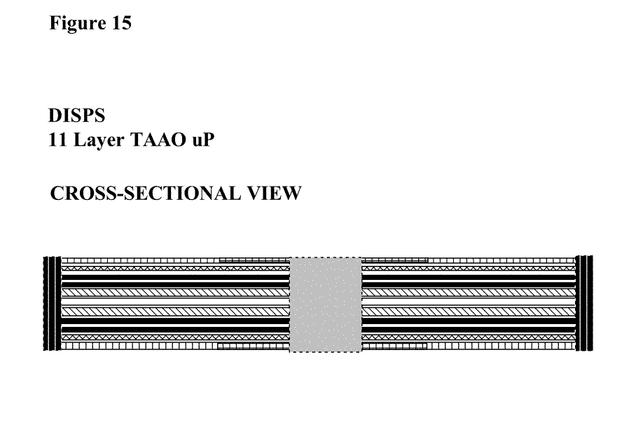

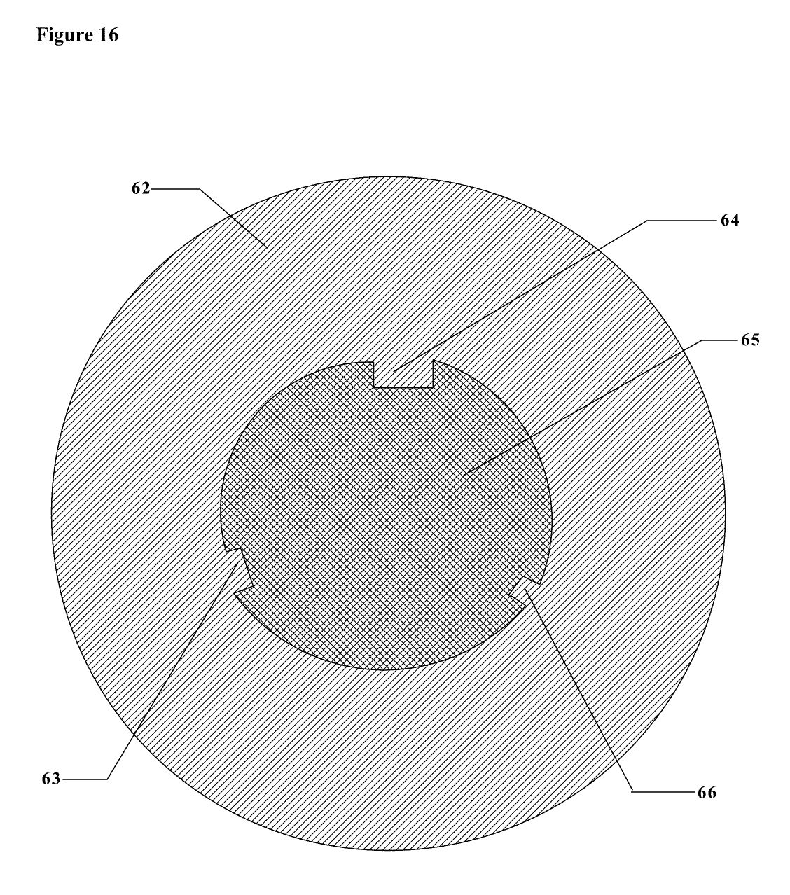

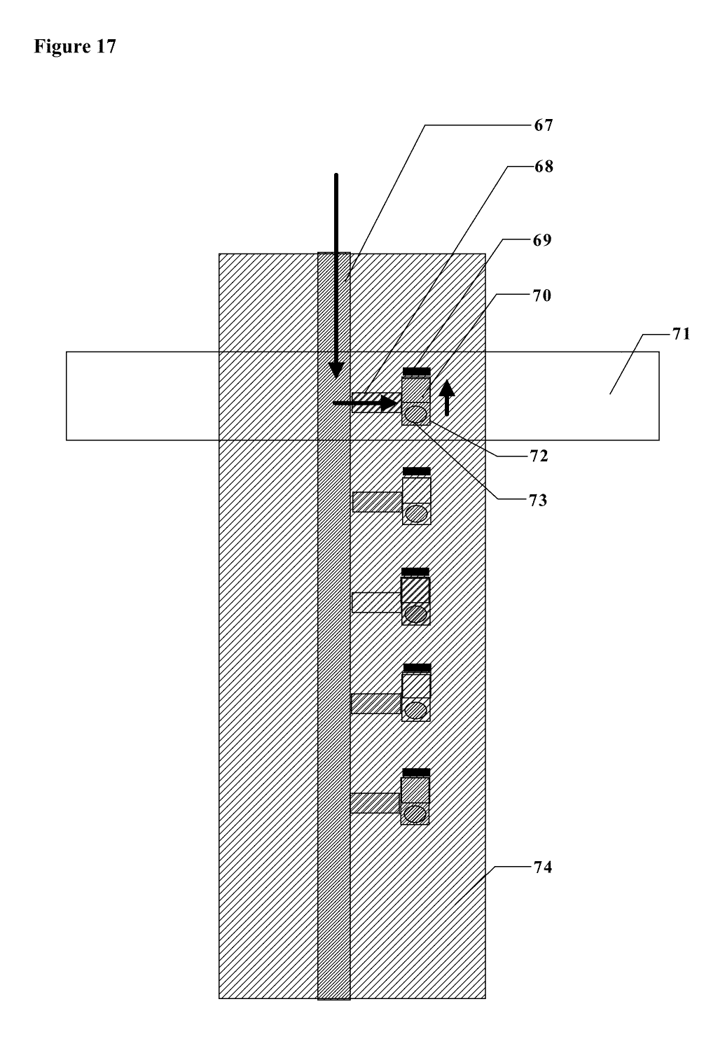

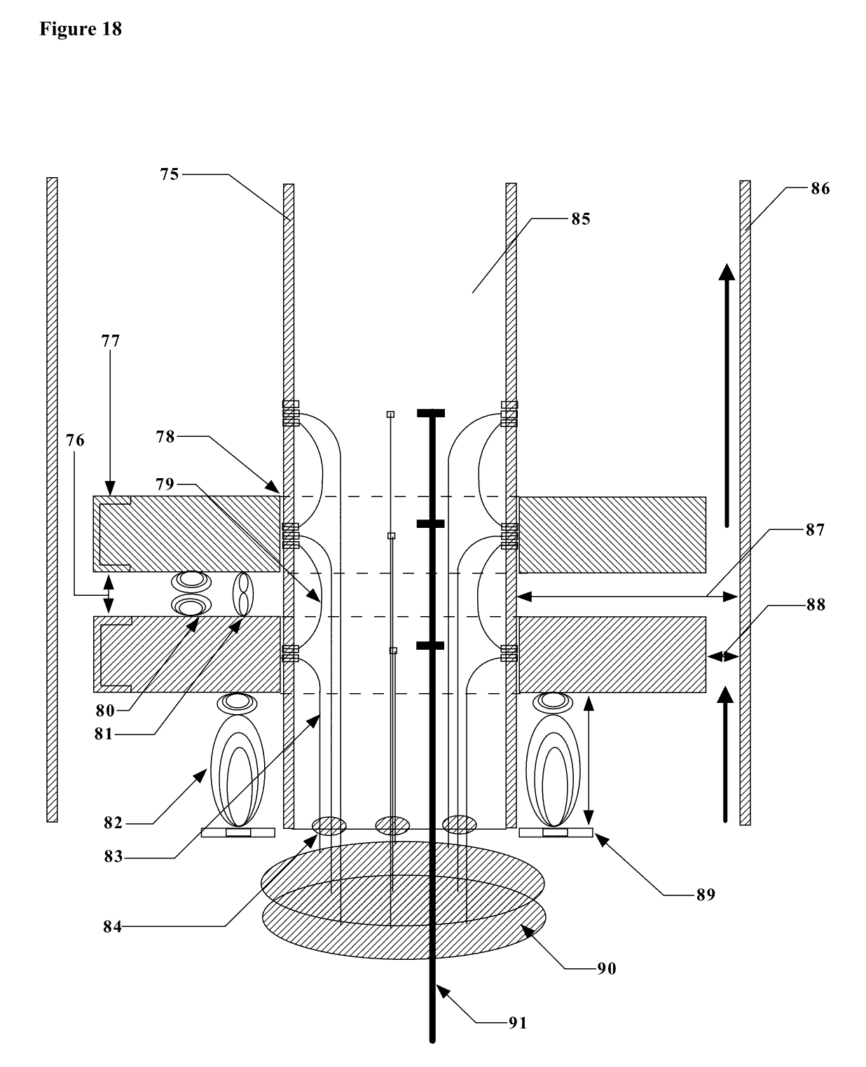

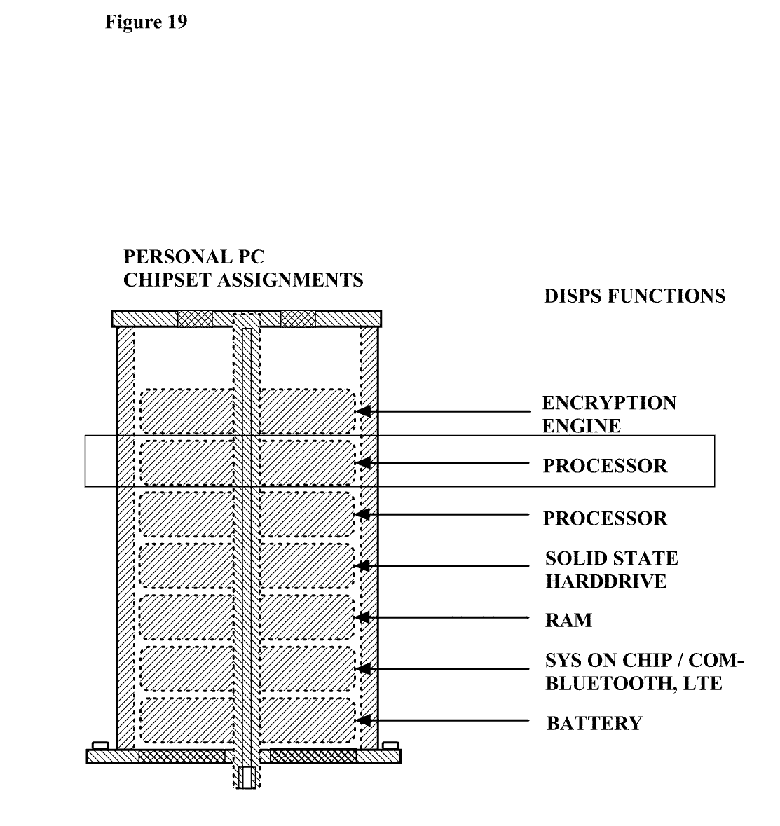

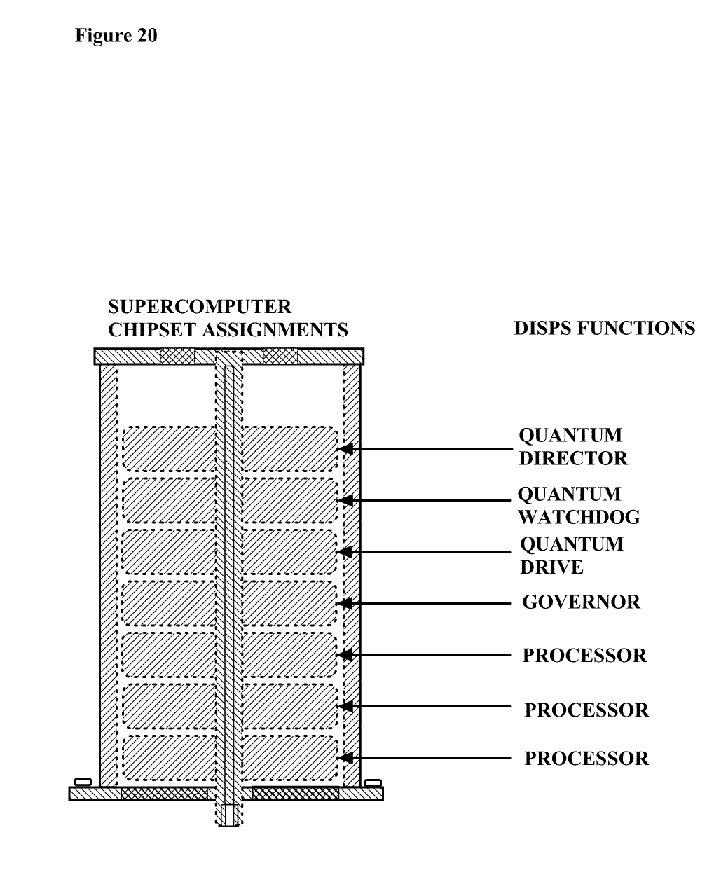

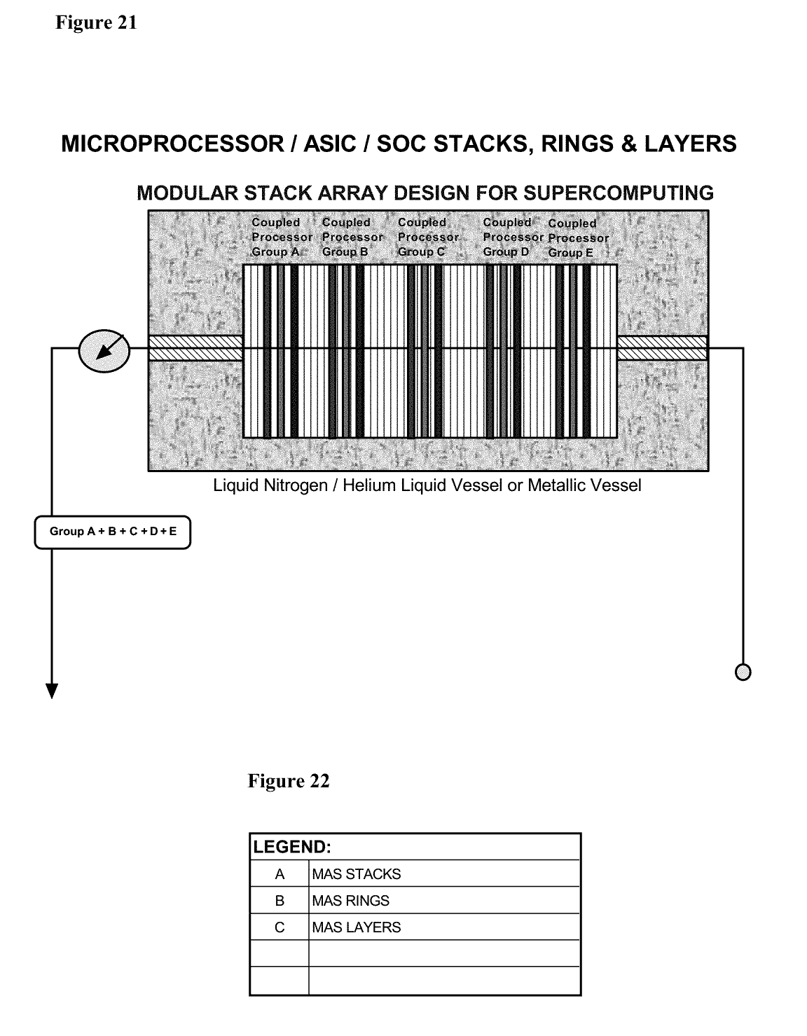

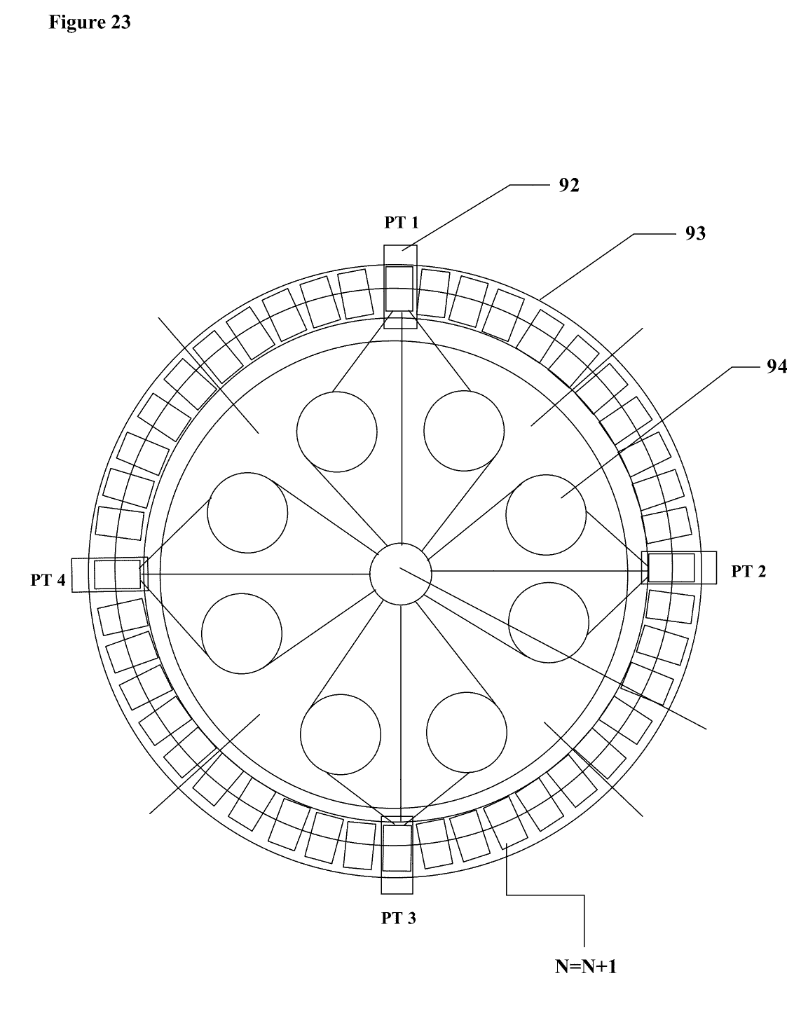

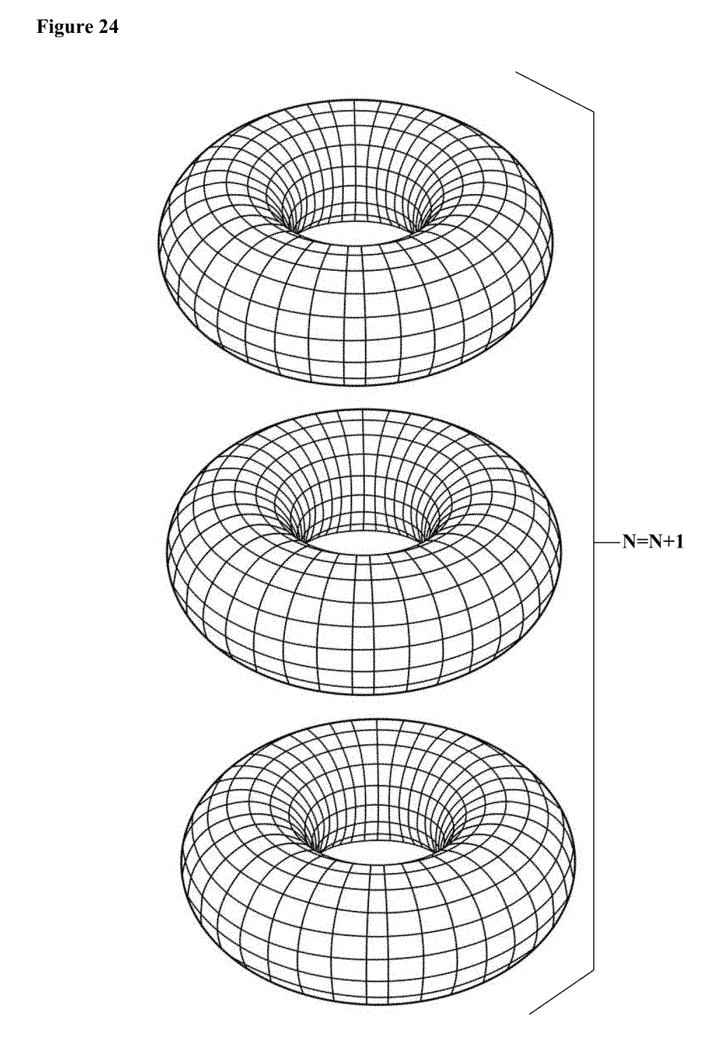

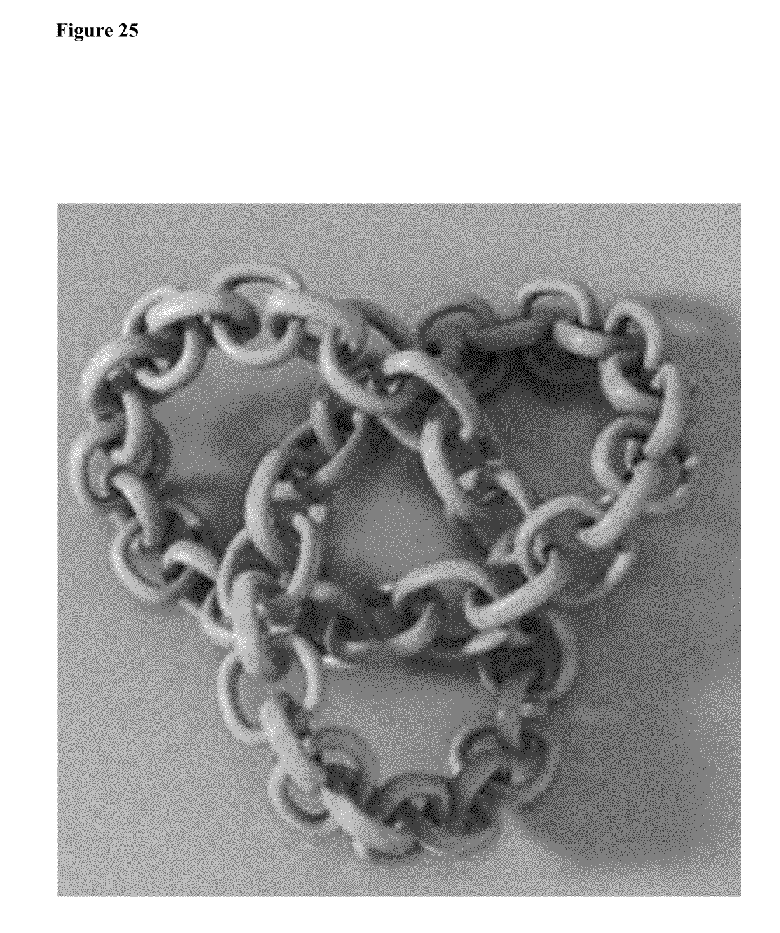

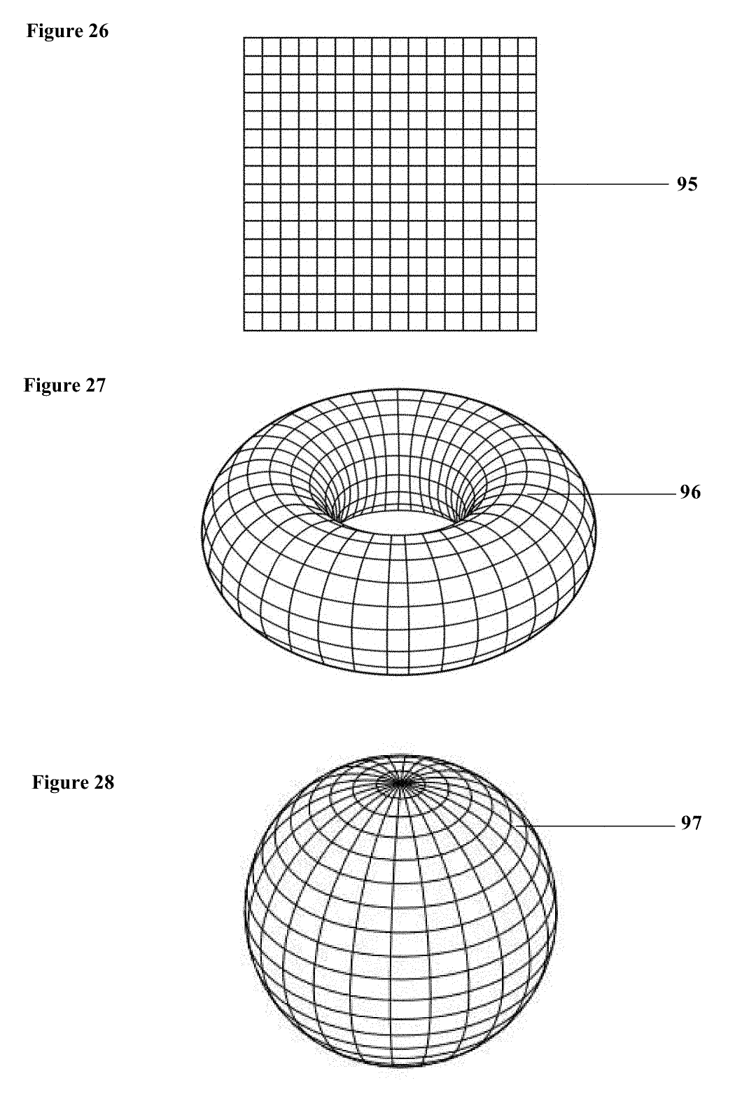

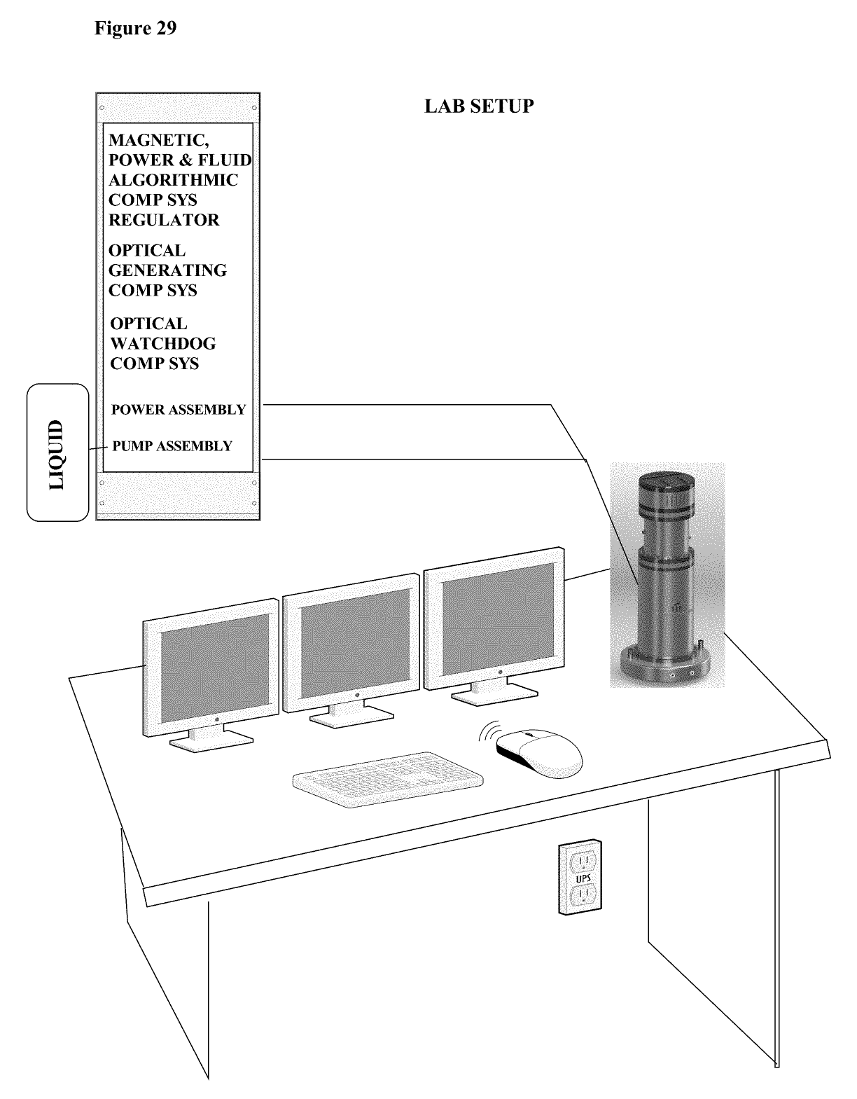

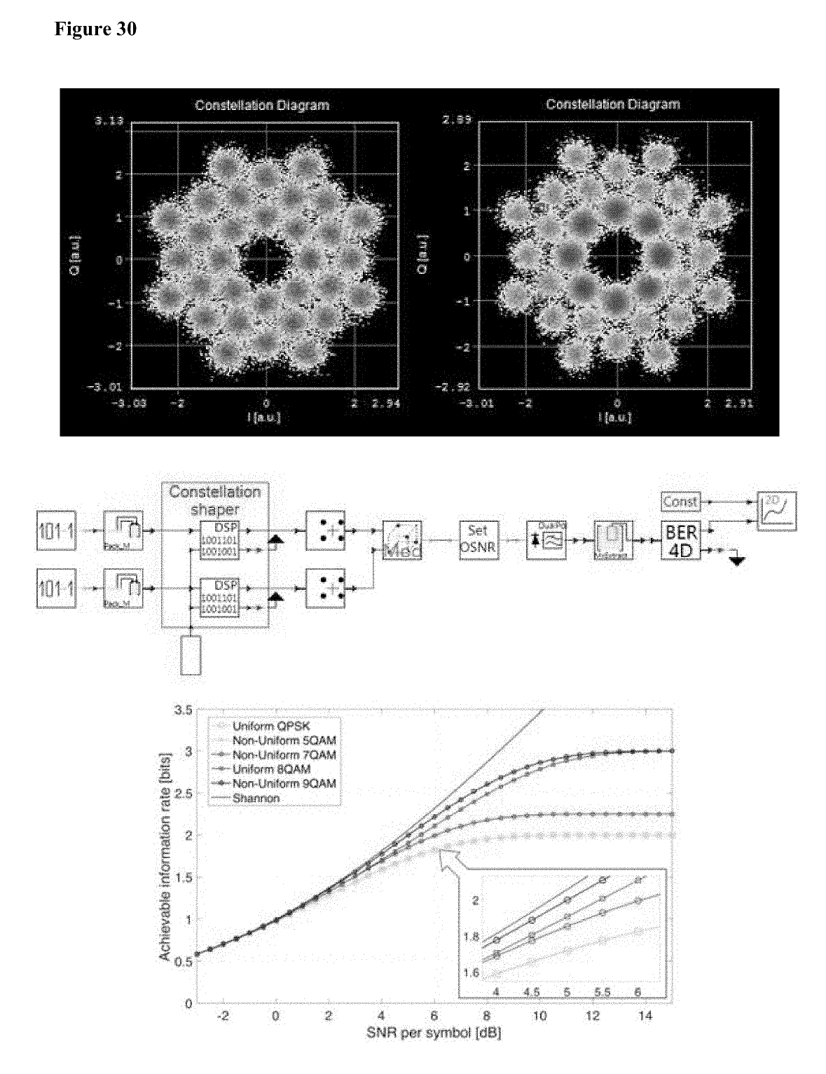

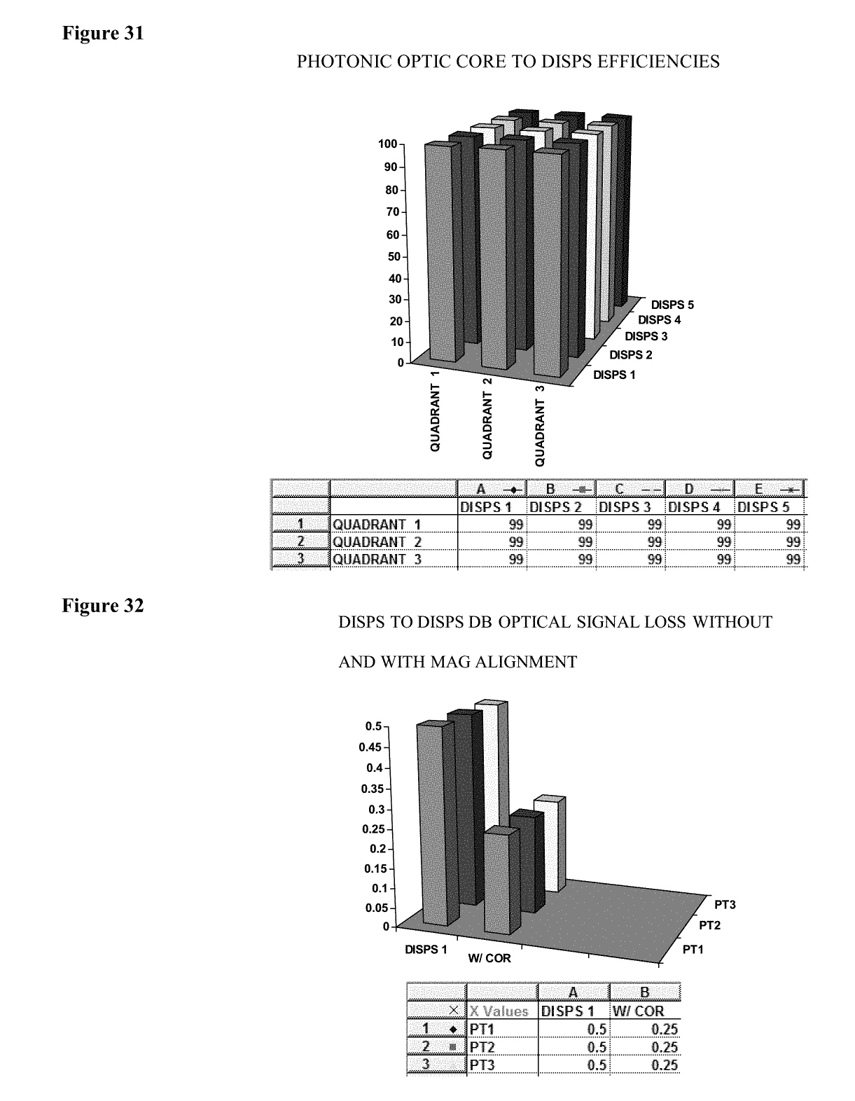

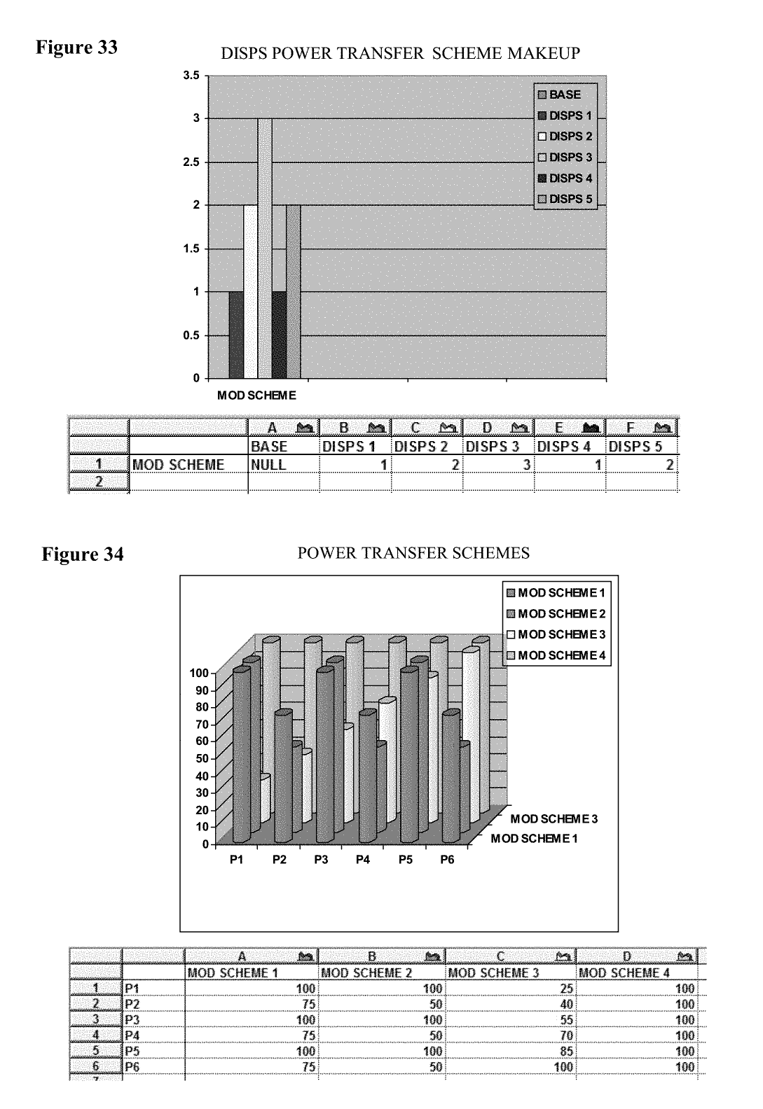

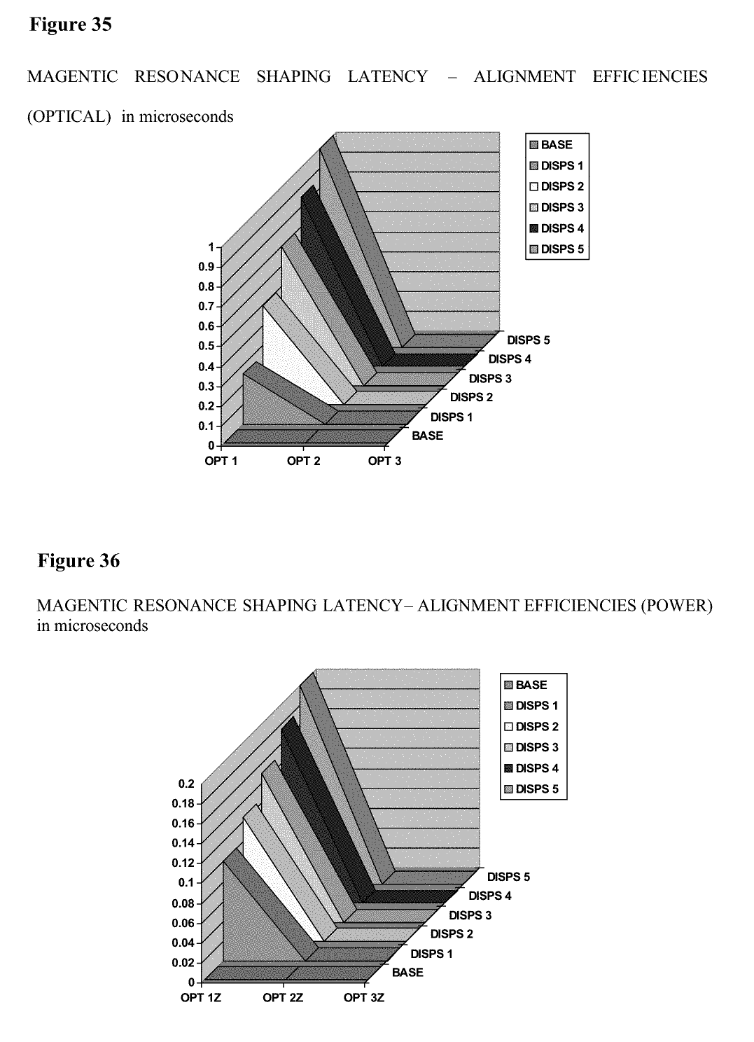

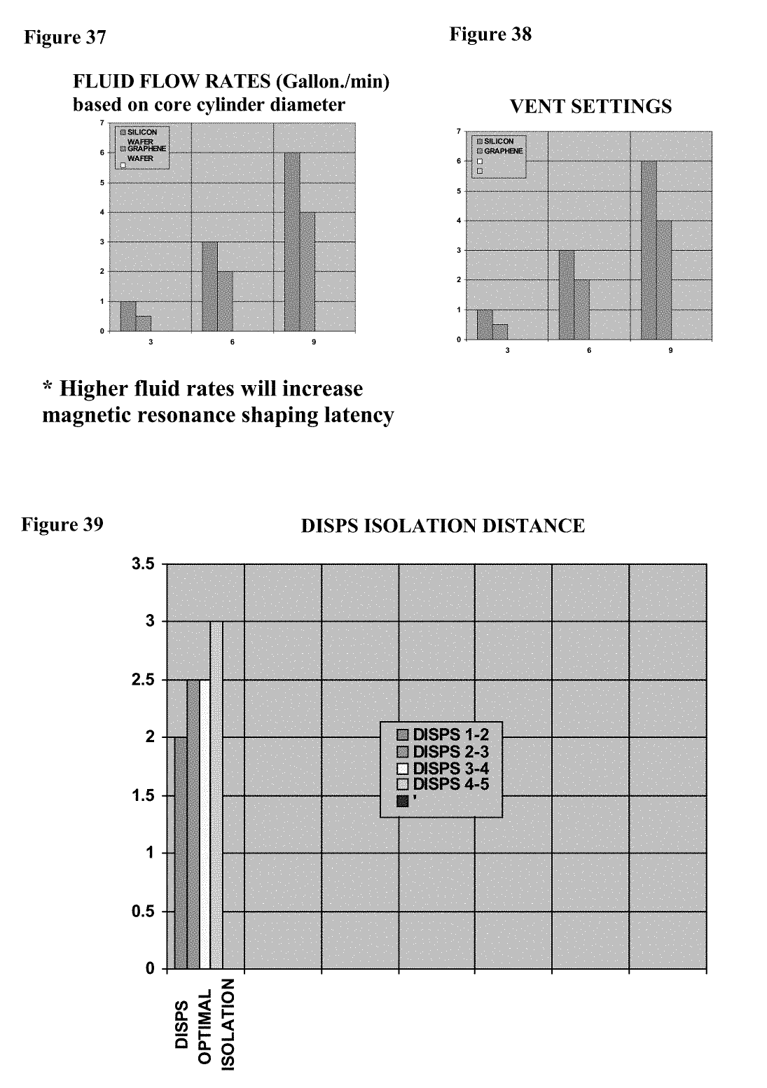

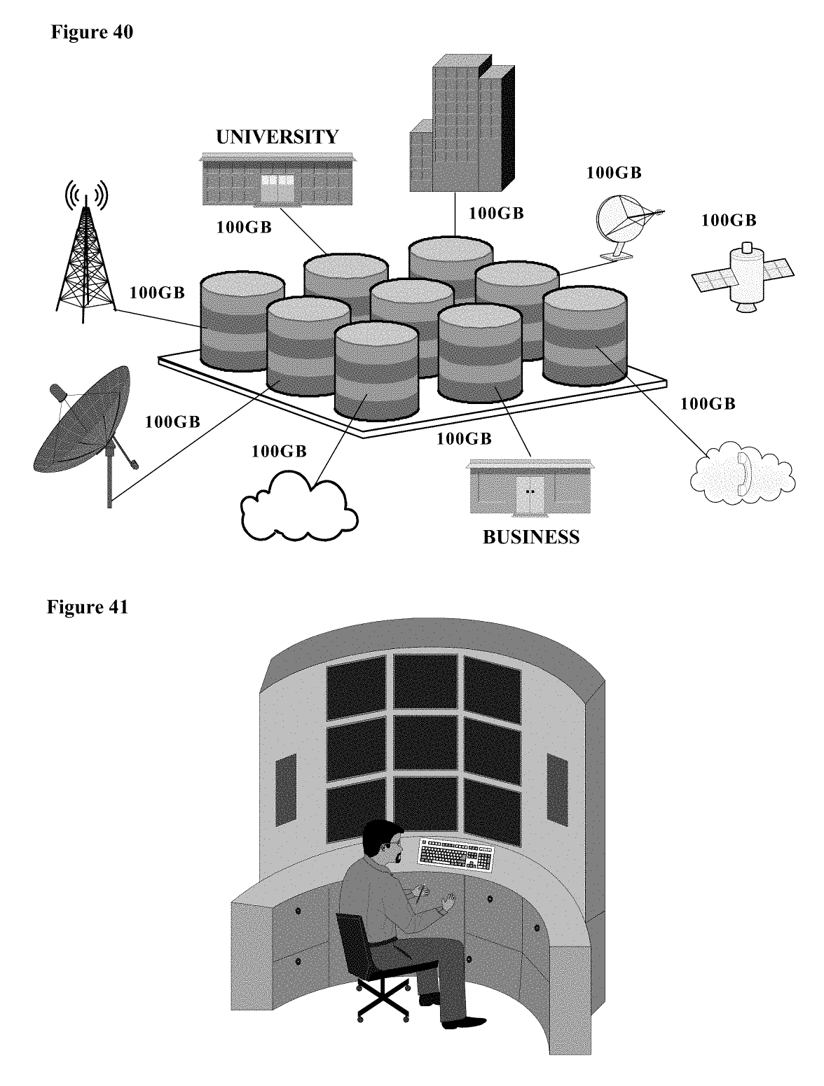

### Review of Section—Chipset Floorplans as Outlined FIGS. 11 Through 15.

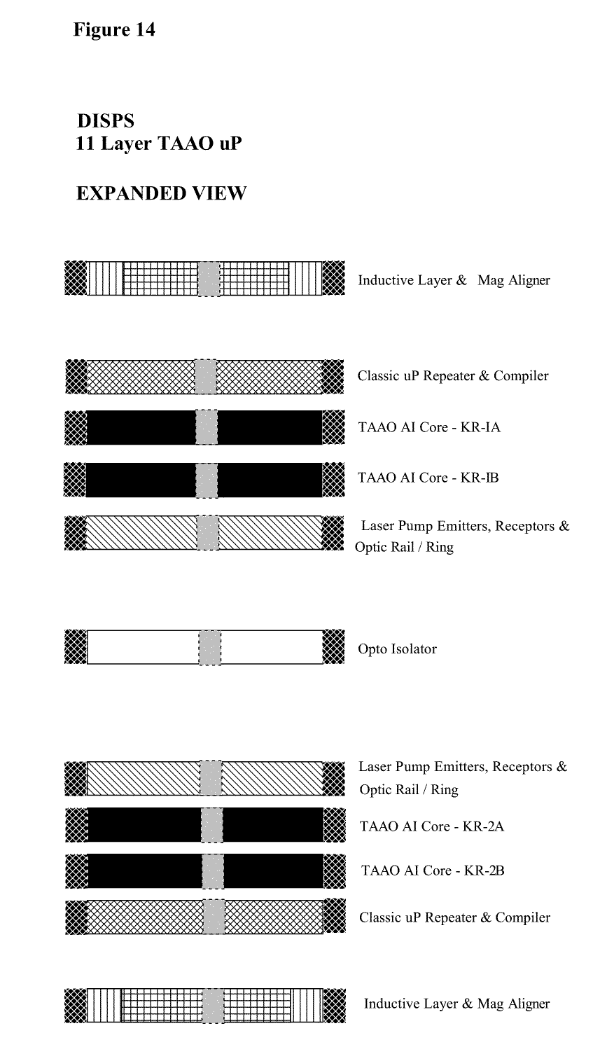

FIG. 11 covers the chip's ring and core layout & base design. FIG. 12 outlines a general cross-sectional view of the outer infrastructure layer of the chip, comprised of many differing substrates. FIG. 13 outlines the magnetic 57 and inductive core membranes 58. FIG. 13 in addition outlines an opto-isolator ring 61, optical ring collector 60 and fiber optic busses 59. FIGS. 14 & 15 go into more detail outlining the chip's functional floorplan.

### Review of Section 5: Chip to Photonic Core Details

A combination of loose 79 & ribbonized fibers 83 in this invention are located within the photonic core tube/fiber optic backplane 85 as shown in FIG. 18. The best solution would be to integrate/embed the fiber-optics to photonic core tube to minimize any undue optical alignments thereby minimizing radial & insertion dB loss. Micro-ferrules comprised of ceramic and or stainless steel are imbedded strategically throughout the photonic core tube/assembly 75 so as to allow maximum optical DISP to Photonic Core alignment 78 as shown in FIG. 18. The Photonic Core Cylinder/Tube contains multiple interlocking channels to securely hold each DISP in place. Multiple tensioner assemblies 73 hold the DISP 71 in place allowing for a secure power connection between contacts 69 & 70 particularly when liquid flow rates reach their maximum. A uniquely keyed 63, 64, 66 DISP 62 as shown in FIG. 16 allows for the proper power connections to the Fiber Optic Core Assembly 65. Power is distributed via a common line/buss 91 within the Photonic Core Tube 85 that runs and connects to the main motherboard. Magnetic Poles 80 help

### Detailed Description of the Preferred Embodiment (Continued)

leverage the DISP placement prior to the interlocking position to prevent any damage to the DISP. Said Magnetic Poles 80 also aid in the removal of the DISP to prevent damage to the Fiber Optic Core Assembly & Cooling Tower. The Flux transfer radiated by coils 89 generate a power field 82 to the nearby DISP. The DISP regenerates said power to its adjacent DISP 81 so as to provide power backup and feedback communication with system. The thermals of the system are dependent of the DISP stack selection required, the number of DISP's in the column, the size of the DISP (3″, 6″, 9″), the conductive plating area & material 77 of each DISP. The size of gaps 76, 87 & 88 would be dependent on the BTU load displacement of DISP and thermal material to be utilized.

### Review of Section 6—Chipset Configurations

There are basically two chipset configurations to be discussed. One is the Chipset Assignment Array (CAA), classified as having a heterogeneous makeup & function as shown in FIGS. 19 & 20. The other is the Modular Stack Array (MSA) which is classified in FIG. 21 as homogenous in function.

### Review of Section 7—Vessel Base Configurations

Fluid Container Types: Made of ceramic, aluminum, copper or stainless steel are suitable for MAS processing for a supercomputing environment. Planar, 95, toroidal 96, and orb 97 liquid containment vessels serve as a base reservoir for coolants such as water, liquid nitrogen, and liquid

### Detailed Description of the Preferred Embodiment (Continued)

Hydrogen and the like. The application of using liquid as an additional coolant is needed when High-end processing is involved or isolation of temp and space noise is deemed necessary. Sites of prime interest would be data center installations, space stations & intra-planetary communication sites.

FIG. 23 depicts N=N+1 DISPS within a Toroid with interconnecting fiber optic cores and multiple power injection points. The center of the toroid containing a fiber optics and power cables.

FIG. 24 depicts N=N+1 a Linear Stacked Toroidal Array.

### Detailed Description of the Preferred Embodiment (Continued)

### DISPS EDA Related Info:

EDA Assistance Programs like MOSIS could aid in the further development of this invention. At MOSIS processors of differing types are designed on one wafer, sent to a fab plant then returned and tested as prototypes.

The key to efficient and effective DISPS involves key material and Bold New EDA Processes. Top US EDA Software Companies include Cadence, Mentor Graphics and Synopsys would have to consider fiber optic core designs and all the other engineering related aspects.

Further development could also be aided by tech savvy Groups & Foundation like the HSA Foundation specializing in Heterogeneous System Architecture (HSA) Foundation, Design and Implementation of Signal Processing Systems Technical Committee and the University of Bristol Microelectronics Research Group.

### Overall Scope:

What has been mentioned of this invention is a preludial overview in nature covering some design and engineering aspects as a whole of the invention. Additional patents are required cover the Bios, Motherboard, Processor Detail, Interfacing Peripherals and Protobiont Heterogeneous Software details. Future versions of the ‘TAAO Tower’ would replace the motherboard as a DISP as well.

What is claimed is:

1. A computer system comprising of a fiber optic hub/core.

2. A computer system comprising of a fiber optic core according to claim 1, wherein said fiber optic core comprises of a single fiber or plurality of fibers.

3. A computer system comprising of a fiber optic core according to claim 2, wherein said Fiber(s) are terminated within a hollow tube strategically placed at differing locations within the said tube.

4. A computer system comprising of a fiber optic core according to claim 3, wherein said fibers couple to other chip(s)/DISPS for throughput.

5. A computer system comprising of a fiber optic core according to claim 4, wherein said chips have augmented/aided alignment with other chips via embedded magnetic poles.

6. A computer system comprising of a fiber optic core according to claim 5, wherein said chips inductively radiate to other chips via inductive oscillation for power and communication.

7. A computer system comprising of a fiber optic core according to claim 6, wherein said chips contain a thermal outer ring.

8. A computer system comprising of a fiber optic core according to claim 7, wherein bios communicates with chip(s)/DISPS to validate and test functionality.

9. A computer system comprising of a fiber optic core according to claim 8, wherein DISPS and fiber optic core are aligned by a key and groove interlock system.

10. A computer system comprising of a fiber optic core according to claim 9, wherein DISPS are directly powered via the fiber optic core via key and groove interlock system.
